(19) United States
(12) Patent Application Publication
(10) Pub. No.: US 2012/0293811 A1
(43) Pub. Date: Nov. 22, 2012

(54) Device and Method for Determining the Position of a Working Surface of a Working Disc

(75) Inventors: Ingo Grotkopp, Kiel (DE); Wolfgang Habbecke, Rendsburg (DE)

(73) Assignee: PETER WOLTERS GMBH, Rendsburg (DE)

(21) Appl. No.: 13/522,459

(22) PCT Filed: Jan. 7, 2011
(86) PCT No.: PCT/EP11/00043

§ 371 Date: Jul. 16, 2012

(30) Foreign Application Priority Data
Jan. 15, 2010 (DE) 10 2010 005 032.6

(51) Int. Cl. G01B 11/14

(52) U.S. Cl. 356/623; 356/614

(57) ABSTRACT

A device for determining the position of a working surface of a working disc of a double-sided machine tool, a double sided grinder in particular, wherein the double-sided machine tool has two working discs, which form a working gap for double sided machining of work pieces between working surfaces facing each other, and of which at least one is rotatingly drivable, wherein the device comprises an optical measurement device having a radiation source, an optical detector device, and an analysis device, designed for being disposed outside of the working gap.

### CROSS-REFERENCE TO RELATED APPLICATIONS

This is a national stage application of PCT/EP2011/000043 Filed on Jan. 7, 2011, the entire content of which are hereby incorporated by reference.

### STATEMENT REGARDING FEDERALLY SPONSORED RESEARCH

Not applicable.

### BACKGROUND OF THE INVENTION

The present invention relates to a device for determining the position of a working surface of a working disc of a double-sided machine tool, a double sided grinder in particular, wherein the double-sided machine tool has two working discs, which form a working gap for double sided machining of work pieces between working surfaces facing each other, and of which at least one is rotatingly drivable, wherein the device comprises an optical measurement device having a radiation source, an optical detector device, and an analysis device, designed for being disposed outside of the working gap. The invention relates also to a method for determining the position of a working surface of a working disc of a double-sided machine tool, a double sided grinder in particular, with the device according to the present invention in particular.

In double sided grinders, finding the position of the working surface, of that of the lower working disc in particular, is of decisive importance during the utilisation of the machine. In-feed parameters for compensating the wear of the working discs are determined in advance by means of process trials. These in-feed parameters describe the number of the in-feed steps and their magnitude and distribution between the upper and the lower working disc. In this, it is a problem that variations in the basic parameters cannot be accounted for. Such variations can be caused in the size of the unmachined part, material of the unmachined part, disc production or associated tolerances respectively, condition and temperature of a coolant, condition of a dresser and so on. Even small variations of such basic parameters can have significant influence on the in-feed ratio, but remain often undetected by an operator in practice.

In the so-called feed-through grinding in particular, there is a comparably high wear when conventional grinding tools (for instance corundum discs) are used. This wear has to be compensated, because otherwise the machined work pieces would become thicker and thicker. This is done by a continuous re-adjustment of one or both working discs, wherein a constant value per unit time can be fed in for instance, or a repeated measurement of the machined work pieces yields the value to be fed in. However, it is a problem that the two working discs on such a double sided grinder do not necessarily wear in the same way. Thus, uniform in-feed of the working discs results in a crawl drift of the working gap. In double sided machine tools for the feed-trough process, the work pieces to be machined are usually guided into the grinding gap or out of the same by means of supply devices and removing devices. The positioning of the supply—and removing devices with respect to the grinding gap has to occur with a precision in the order of magnitude of 10 μm, in order that the work pieces can run in or out without problems. Position change of the grinding gap is problematic insofar, and has hitherto been avoided by periodic dressing. By this, a new reference surface is created always anew on the working disc, whose location is known from the position of the dressing tool. However, because each dressing process annihilates a comparably great amount of the volume of the grinding disc, this way of referencing is sumptuous and undesired. The same problem can occur in machine tools with planetary kinematics, in which the work pieces are held in rotor discs and are moved in the working gap along cycloidal paths. In this machining method, the work pieces can be charged and discharged automatically at the beginning and the end of the machining, for which purpose the position of the working surface has to be known precisely also.

In DE 24 27 709, mechanical scanning of the working disc's surface by means of a pendulum type tracer in contact with the disc is proposed. In DE 195 37 586 A1, optical measurement for determining surfaces, surface profiles and volumes by means of confocal imaging is proposed, wherein beams are sent to the object via an optical fibre bundle and are reflected from the same and fed to a detector which performs simultaneous intercept of the reflected rays. However, both measurement methods have the drawback that they yield steadily good measurement data only at standstill of the machining tool. Mechanical measurement tracers as known from DE 24 27 709 A1 are subject to significant wear upon measurements on a running machine tool, a grinder in particular, when they come into contact with the working surface. This problem could not be resolved even by optimized designs of the sensors with respect to shaping, coating or reduction of the tracking force. The known optical systems are hampered by the fact that during the operation of the machining tool, there will be machining media, like for instance cooling lubricants, and rubbed-off particles in the measurement area between sensor and working disc, whereby the measurement is negatively affected or made impossible. Thus, the machining process has to be interrupted for measurement, which is undesired in principle.

For mapping the circumferential area of rotating tools, a Doppler method on the basis of electromagnetic radiation is proposed in DE 198 13 041 A1, which is claimed to be insensitive against cooling lubricants and particles. However, only a change of the surface speed of a working disc can be detected by this method, which change occurs in particular when a circumferential working disc running at constant speed experiences reduction of its diameter through wear. However, wear of an abrasive layer on the front side of a grinding disc cannot be determined by this method, neither a position change of an abrasive layer.

A particular problem in the measurement at running operation of double sided machine tools is the usually very narrow working gap. Thus, the desired thickness of the machined work pieces is given by the distance of the two working discs with respect to each other. In many cases, this distance is in the order of magnitude of a few millimetres. Known sensors cannot be used for measurement in the working gap for this reason.

### BRIEF SUMMARY OF THE INVENTION

Starting from the known state of the art, the present invention is based on the objective to provide a device and a method of the kind mentioned in the beginning, by which the position of the working surface of a working disc can be reliably determined even at narrow working gap and in the operation of the machine tool.

The present invention achieves this task by the subject matters of the independent claims 1 and 13. Advantageous embodiments are found in the dependent claims, the description and the figures.

For a device of the kind mentioned in the beginning, the present invention achieves the task in that the optical measurement device comprises a beam guiding device which is designed for being at least partially inserted in the working gap, wherein the beam guiding device has an exit opening for optical radiation generated by the radiation source, said exit opening being situated in the working gap when the beam guiding device is inserted into the working gap, and wherein the beam guiding device guides the optical radiation emitted by the radiation source substantially parallel to the working surfaces into the working gap at first, deflects said radiation onto a working surface at a measuring point by means of at least one deflecting surface, receives radiation reflected by the working surface and guides said radiation back out of the working gap to the optical detector device, the analysis device being designed to determine the position of the working surface by means of a detection result of the detector device, and in that the beam guiding device comprises a fluid inlet connected to a fluid supply, by means of which at least one measurement area permeated by the optical radiation after exiting the exit opening of the beam guiding device in the working gap can be flushed.

For a method of the kind mentioned in the beginning, the present invention achieves the task by the steps:
a beam guiding device is at least partially inserted into the working gap, wherein the beam guiding device has an exit opening for optical radiation generated by the radiation source, said exit opening being situated in the working gap when the beam guiding device is inserted in the working gap,
optical radiation generated by an optical radiation source is guided, coming from the radiation source, substantially parallel to the working surfaces into the working gap by the beam guiding device at first, deflected onto a working surface at a measuring point by means of at least one deflecting surface,
radiation reflected by the working surface is received by the beam guiding device and guided back out of the working gap to an optical detector device,
the position of the working surface is determined by means of a detection result of the detector device, and
at least during guiding the optical radiation onto the working surface and receiving the radiation reflected by the working surface, a measurement area permeated by the optical radiation after exiting the exit opening of the beam guiding device in the working gap is flushed.

According to the present invention, a distance, a vertical distance in particular, of the working surface relative to a reference position is determined for determining the position of the working surface, for instance to a reference position of the optical measurement device. For instance, the distance of the working surface to a point on the deflecting surface of the beam guiding device or to a reference point of the detector device can be determined, the locations of these points being known. On the one hand, the present invention is based on the idea that the components of the optical measurement device which require greater constructional space are disposed outside the working gap, wherein by means of the beam guiding device, only the measuring beam is introduced into the working gap and guided out of it again. Thus, the part of the device disposed within the working gap occupies only a very small constructional space, so that the measurement is possible without problems even at very narrow working gaps. Moreover, the beam guiding device comprises a fluid supply, by means of which the region around the exit opening of the radiation and in particular that between the exit opening and the working surface can be flushed free, so that disturbing influences through machining media, like cooling lubricant e.g., do not occur. A gas or a liquid can be supplied for flushing via the fluid supply. Nitrogen, pressurized air, water, oil are mentioned by way of example. The measurement according to the present invention should take place comparably near to the edge of the working disc or of the working surface, respectively, because this edge is particularly critical with respect to wear. The components of the optical measurement device outside of the working gap, namely the radiation source, the detector device and the analysis device in particular, can be arranged in a protection casing outside of the working gap or the perimeter of the working disc, respectively, in order to be protected against accumulation of dirt or entrance of machining media.

Deflection mirrors or deflection prisms may be used as deflecting surface, e.g. The optical radiation reflected by the working surface can be guided out of the gap via the same path or via another path than that via which it had been introduced into the gap. The double sided machining tool may be a double sided grinder, for surface grinding of flat work pieces in particular. In grinders, there is a high wear of the working surfaces, and therefore a particular need for the position determination of the present invention. By way of example, the working gap may have a thickness of less than 5 mm, and less than 3 mm in particular.

It was demonstrated that the position of the working surface can be safely measured by the method of the present invention or the device of the present invention, respectively, with a measurement error of less than 5 μm on a working gap having a width of not more than 2 mm, even during a running machining process, a grinding process in particular.

In order to assure that no dirt or machining media can enter into the beam path in undesired manner, the beam guiding device can have a guide channel ending in the exit opening for guiding the optical radiation in the working gap, wherein the at least one deflecting surface is disposed within the guide channel, for instance at the end of the guide channel. The fluid for flushing the measurement area may also be supplied via the channel, and exit from the channel via the same exit opening as the optical radiation.

However, it is also conceivable to guide the optical radiation in an optical fibre, or to form the channel by a transparent beam guiding medium, a transparent solid material for instance, like acrylic glass. In both cases mentioned above, the radiation and the fluid are separately supplied to the measurement range.

In a particularly practical manner, the optical radiation source may be a laser source. Further, the analysis device can be designed to determine the position of the working surface by means of a runtime measurement of the optical radiation. By analysing the runtime of the optical radiation between the moment of its emission by the optical radiation source and the moment of its detection by the detector device, the path covered by the optical radiation from the radiation source to the working surface and back to the detector can be found out in a per se known manner. The position of the working surface relative to the optical radiation source and/or the detector device can be determined through this. However, the optical measurement device may also be a triangulation type device. Measurement devices based on the triangulation principle are per se known and commercially available. Besides to measuring the distance of the working surface from a reference point, it is also conceivable to determine a topography of the working surface by triangulation measurement in that optical radiation is guided onto the working surface by means of suitable optics along a line. Such methods are per se known for those skilled in the art.

In the implementation of the method during the double sided machining of work pieces in the working gap, a measurement profile along the perimeter direction of a circle with the radius of the impingement point of the beam on the working surface will be acquired, by nature even at fixed positioning of the beam guiding device. According to a further embodiment, an adjustment device can be provided by means of which the beam guiding device can be moved into the working gap and out of the working gap. By way of example, the adjustment device can have a pivot arm holding the beam guiding device, by means of which the beam guiding device can be swivelled into the working gap and out of the working gap. Thus, the beam guiding system may be movable, so that it can be moved into the working gap for measurement at one side, and subsequently be moved out of the gap. This is conceivable for instance in machine tools with planetary kinematics, so that the beam guide system is moved into the gap or out of the same in sync with the movement of a rotor disc. However, it is also conceivable to perform a measurement at different sites by such an adjustment device, at different radial sites in the embodiment with a pivot arm. A surface profile of the working disc can be determined through this. It is also conceivable to mount the beam guiding device on a rail by which it can be moved into the working gap or out of the same, respectively. For example, a surface profile can be used with the aid of the analysis device, in order to detect a difference of the working surface's profile from a desired profile which is caused by wear.

Further measures can then be taken on this basis. For example, the machining process can be stopped when a given limit difference between the measured working surface profile and the desired profile is exceeded. The operator of the machine can also be given a message, for example that a dressing process is necessary for the working discs. It is also possible to select an optimum dressing process for the working discs from the respective measured surface profile of the working disc by means of the analysis device, the process generating minimum wear on the dressing tool and on the working disc. In machining tools with planetary kinematics in particular, the early detection of a change of the working disc profile can be compensated by suitable adaptation of the process parameters, so that the number of necessary dressing actions is reduced altogether. The adaptation of the process parameters can be selected automatically or manually on the basis of the analysis data of the analysis device.

As already mentioned, the beam guiding device of the present invention is so flat that in can be inserted also into particularly narrow working gaps. In particular, the beam guiding device can have a height of less than 5 mm, and less than 3 mm in particular, in a direction running vertically to the main beam guiding direction (thus, usually in the vertical direction when the device is being operated).

According to a further embodiment, it can be provided that the device has a second beam guiding device, designed to be at least partially inserted into the working gap, wherein the second beam guiding device has an exit opening for optical radiation generated by the radiation source, said exit opening being situated in the working gap when the second beam guiding device is inserted into the working gap, and wherein the second beam guiding device guides the optical radiation emitted by the radiation source substantially parallel to the working surfaces into the working gap at first, deflects said radiation onto the respective other one of the two working surfaces at a measuring point by means of at least one deflecting surface, receives radiation reflected by this working surface and guides said radiation back out of the working gap to the optical detector device, an analysis device being designed to determine the position of this working surface by means of a detection result of the detector device, and that the second beam guiding device also comprises a fluid inlet connected to a fluid supply, by means of which at least one second measurement area permeated by the optical radiation after exiting the exit opening of the second beam guiding device in the working gap can be flushed. In this, it is possible to provide a second radiation source, second detector device, second analysis device and/or second fluid supply for the second radiation path. But it is also conceivable to provide a common radiation source, detector device, analysis device and/or fluid supply for both radiation paths. By combining two measurement paths with corresponding components, either in one casing or in two separate casings, both working discs can be measured simultaneously in a double sided machine tool. Thus, it is possible to measure the working gap itself. In particular with the narrow dimension tolerances of ground work pieces, the dimension of the working gap must be observed very accurately. The working gap dimension is subject to significant disturbing influences in practice, like e.g. wear of the working discs, thermally caused deformation of machine components (frame, spindle etc.) or elastic deformation due to force action. In known machines for double sided surface grinding, in the feed-through method in particular, it is attempted to minimize these disturbing influences by 100%-measurement of the machined components, as well as by temperature control devices and a particularly stiff construction of the machine frame. However, this is possible with justifiable expenditure only in a limited degree. By directly measuring the working gap at the working disc surfaces, these disturbances can be acquired in common and can be compensated by a suitable adjustment via the analysis device, by feeding in the working discs correspondingly. Unequally higher machining precisions result than with the known solutions.

The double sided machine tool can be a through-feed machine tool, in which each work piece to be machined is guided into the working gap and out of the same during its machining process. Such through-feed machine tools (also called Double Disc Grinding (DDG) machines) necessitate accurate recognition of the wear of the working surfaces and the inadmissible gap change accompanied by this, due to the great number of work pieces entering into the working gap. Otherwise, inaccurate insertion of the work pieces into the working gap and machining errors through this can occur. In through-feed machine tools in particular, measurement of the position of the working surface is possible even during the machining of the work piece.

However, it is also possible that the double sided machine tool works according to the principle of planetary kinematics, that is to say, at least one rotor disc is disposed in the working gap, said rotor disc receiving work pieces to be machined in recesses and being adapted to be rotated by means of a roll off device, whereby the at least one rotor disc, and together with it the work pieces received therein, move in the working gap along cycloidal paths. Here, the advantage is that in particular when the working disc is adjustable, the disc shape can be measured also, a disc topography in particular. This can be of decisive importance in the adaptation of machines with planetary kinematics.

According to a particularly preferred embodiment, the double sided machine tool can comprise a control system, which adjusts the position of the working surface and/or the width of the working gap to a constant value, based on the position of the working surface determined by the analysis device. For this purpose, a working disc adjustment device may be provided, which is designed to adjust at least that working disc particularly in its vertical position, which comprises the working surface measured by the optical radiation. For example, the thickness of the working layer of the measured working disc can decrease due to wear. In this case, the working disc adjustment device can be controlled such by the control system that it re-adjusts the corresponding working disc into a position again in which the working surface occupies its given desired position again, and/or the working gap its given desired width again.

### BRIEF DESCRIPTION OF THE SEVERAL VIEWS OF THE DRAWINGS

An example of the realisation of the present invention will be explained in more detail below by way of figures. They show in a schematic manner:

FIG. 1 a device of the present invention in a side view,

FIG. 2 an enlarged cut-out of the device from FIG. 1, in a sectional view,

FIG. 3 a top view onto the device from FIG. 1,

FIG. 4 a view corresponding to the view of FIG. 3, wherein the upper working disc is not shown,

FIG. 5 a view of the device of the present invention, partly in perspective,

FIG. 6 an enlarged cut-out corresponding to the cut-out A from FIG. 2,

FIG. 7 an enlarged cut-out corresponding to the cut-out B from FIGS. 4, and

FIG. 8 a diagram with a measurement signal recorded with the method of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

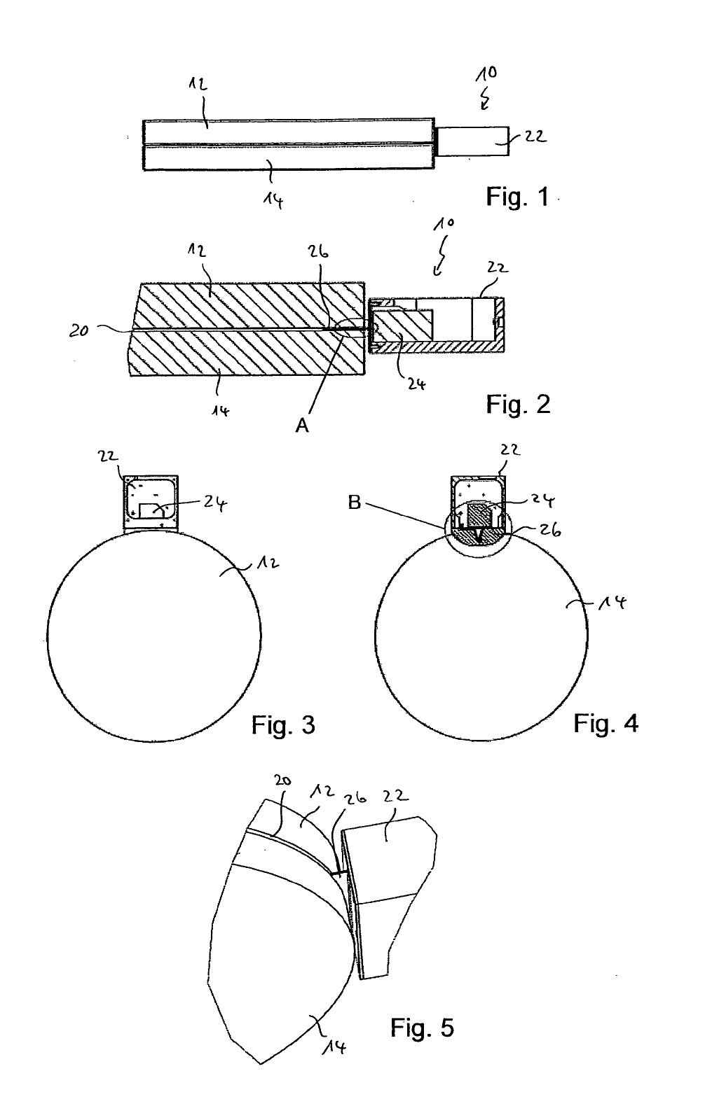

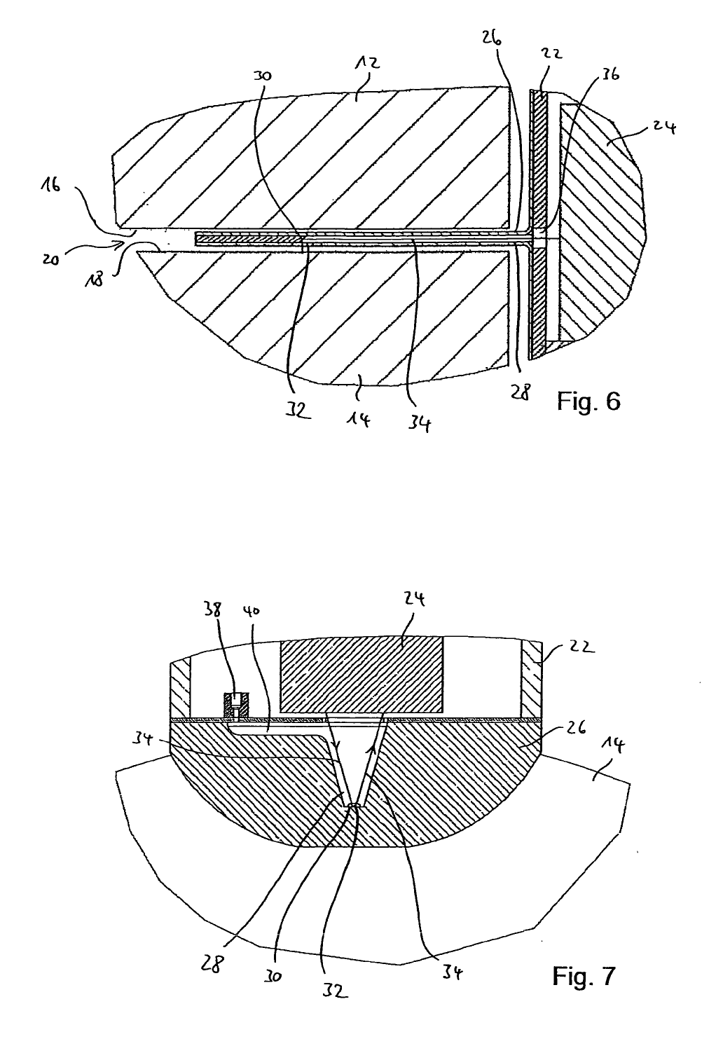

So far as not indicated otherwise, same reference signs indicate same objects in the figures. In FIGS. 1 to 7, a device 10 of the present invention for determining the position of the working surface of a working disc of a double sided grinder is shown. For reasons of clarity, only the upper working disc 12 and the lower working disc 14 of the double sided grinder are shown in the figures. At least one of the cylindrical working discs 12, 14 is rotatingly drivable around a vertical rotation axis via a suitable drive in a per se known manner. The upper working disc 12 comprises an upper working surface 16 which can be recognised in the enlarged view in FIG. 6 in particular. The lower working disc 14 comprises a lower working surface 18 facing the working surface 16 of the upper working disc 12. The working discs 12, 14 delimit a working gap 20 between the working surfaces 16, 18. In the shown example, the working discs 12, 14 are a part of a double sided grinder according to the feed-through method, wherein the work pieces to be machined are guided into and out of the working gap during a machining process by means of a supply device not shown in more detail. This is per se known and will not be explained in more detail. Of course it would be also conceivable that the double sided grinder is a double sided grinder with planetary kinematics, wherein the work pieces to be machined are situated in rotor discs disposed in the working gap, and are moved along cycloidal paths in the working gap together with the rotor discs.

In the shown example, the device 10 of the present invention has an optical measurement device 24, which is disposed in a protection casing outside the working gap 20. In the shown example it is a per se known triangulation sensor, comprising a laser source, an optical detector device and an analysis device. While the protection casing 22 is disposed outside the working gap 28, a beam guiding device 26, approximately in the form of a half oval when seen from the top, is inserted into the working gap 20. The beam guiding device 26 comprises a channel 28, on whose end turned away from the casing 22 is provided a deflecting surface 30 for optical radiation, recognisable in FIG. 6 in particular and being inclined about 45° with respect to the vertical, and formed for instance by a deflecting mirror or a deflecting prism. In the area of the deflecting surface 30, the channel 28 has an exit opening 32, opened towards the lower working surface 18. In the operation, laser radiation 34 emitted by the laser source is guided through an opening 36 of the casing 22 into the channel 28, and thereby parallel to the working surfaces 16, 18 in the working gap 20 and towards the deflecting surface 30. The radiation 34 is deflected downward about 90° to the lower working surface 18 by the deflecting surface 30. The radiation 34 is reflected by the lower working surface 18 and comes back to the deflecting surface 30, which in turn deflects it about 90° into a direction parallel to the working surfaces 16, 18 and out of the working gap. After passing through the channel 28, the radiation comes back through the opening 36 into the casing 22 again, and to the optical detector device. The analysis device determines the position of the lower working surface 18 relative to a reference position of the optical measurement device of the triangulation principle type, which is disposed in the casing 22.

In FIG. 7, one furthermore recognises that the beam guiding device 26 has a fluid supply 38 connected to a fluid accommodation not shown in more detail. In the shown example, pressurized air is supplied to the channel 28 via a supply channel 40 from the fluid supply 38, so that the pressurized air flows also through the channel 28 and hits the lower working surface 18 through the exit opening 32. Thus, channel 28 and in particular exit opening 32, as well as the measurement area between the exit opening 32 and the impingement point of the optical radiation 34 on the lower working surface 18 are flushed. As a consequence, corruption of the measurement due to machining media or other contaminations, like rubbed-off particles, does not occur.

From the operation position shown in the figures, the casing 22 and together with it the beam guiding device 26 can be swivelled around a vertical axis and out of the working gap 20. Thus, it is possible to introduce the device into the working gap 20 for one measurement process only. However, it is also possible to acquire a surface profile of the lower working surface 18 by swivelling the beam guiding device during a measurement process. Even though this is not shown in the figures, a second beam guiding device may be provided in addition, which guides optical radiation to the upper working surface 16 in a manner analogous to that which is shown in the figures, in order to detect its position also. The construction and the function of the second beam guiding device can be identical with the beam guiding device 26 shown in the figures. It is possible to utilize the components of the optical measurement device 24 for the second beam guiding device also. But it is also possible to provide these components for the second beam guiding device separately. On the basis of the measurement of both working surfaces 16, 18, a direct measurement of the thickness of the working gap 20 is possible by means of the analysis device.

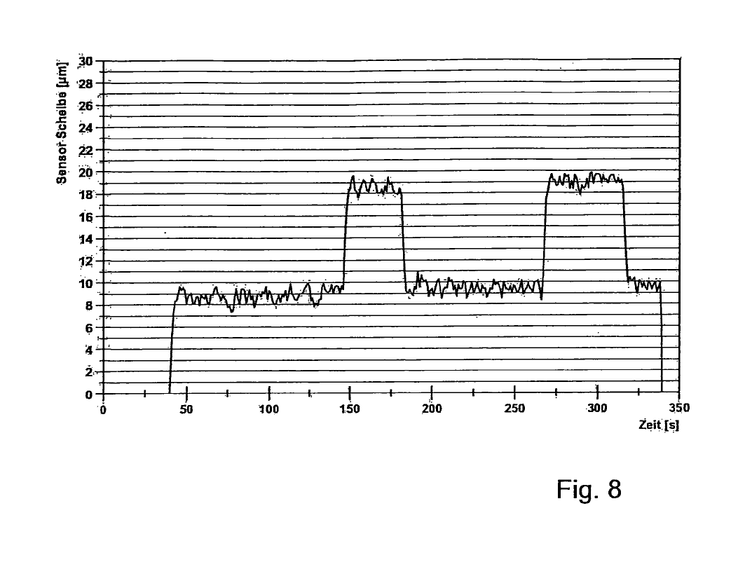

A course in time of a position of the lower working surface 18 relative to a reference position, determined with a device of the present invention, is shown in FIG. 8, wherein the lower working surface 18 has been adjusted downward for approximately 10 μm, for example in the time spans of about 150 s to 180 s and 275 to about 320 s. The data were taken on a machine of type DDG600 of the applicant company, with a conventional grinding disc. As can be further recognised from FIG. 8, the measurement according to the present invention is accurately possible with a measurement tolerance of a few micrometers.

This completes the description of the preferred and alternate embodiments of the invention. Those skilled in the art may recognize other equivalents to the specific embodiment described herein which equivalents are intended to be encompassed by the claims attached hereto.

1. Device for determining the position of a working surface of a working disc of a double-sided machine tool, a double sided grinder in particular, wherein the double-sided machine tool comprises two working discs (12, 14), which form a working gap (20) for double sided machining of work pieces between working surfaces (16, 18) facing each other, and of which at least one is rotatingly drivable,
wherein the device comprises an optical measurement device (24) having a radiation source, an optical detector device, and an analysis device, designed for being disposed outside of the working gap, wherein
the device comprises a beam guiding device (26), designed for being at least partially inserted in the working gap (20), wherein the beam guiding device (26) has an exit opening (32) for optical radiation (34) generated by the radiation source, said exit opening being situated in the working gap (20) when the beam guiding device (16) is inserted into the working gap (20), and wherein the beam guiding device (16) guides the optical radiation (34) emitted by the radiation source substantially parallel to the working surfaces (16, 18) into the working gap (20), deflects said radiation onto a working surface (16, 18) at a measuring point by means of at least one deflecting surface (30), receives radiation reflected by the working surface (16, 18) and guides said radiation back out of the working gap (20) to the optical detector device, the analysis device being designed to determine the position of the working surface (16, 18) based on a detection result of the detector device, and
the beam guiding device (26) comprises a fluid inlet (38) connected to a fluid supply, by means of which the at least one measurement area permeated by the optical radiation (34) after exiting the exit opening (32) of the beam guiding device (26) in the working gap (26) can be flushed.

2. Device according to claim 1, wherein the beam guiding device (26) has a guide channel (28) ending in the exit opening (32) for guiding the optical radiation (34) in the working gap (20), wherein the at least one deflecting surface (30) is disposed within the guide channel (28).

3. Device according to claim 1, wherein the optical radiation source is a laser source.

4. Device according to claim 1, wherein the optical measurement device (24) is a triangulation type measurement device (24).

5. Device according to claim 1, wherein an adjustment device is provided by means of which the beam guiding device (26) can be moved into the working gap (20) and out of the working gap (20).

6. Device according to claim 5, wherein the adjustment device has a pivot arm holding the beam guiding device (26), by means of which the beam guiding device (26) can be swivelled into the working gap (20) and out of the working gap (20).

7. Device according to claim 1, wherein the beam guiding device (26) has a height of less than 5 mm, and less than 3 mm in particular.

8. Device according to claim 1, wherein the device (10) has a second beam guiding device, designed to be at least partially inserted into the working gap (20), wherein the second beam guiding device has an exit opening (32) for optical radiation generated by the radiation source, said exit opening being situated in the working gap (20) when the second beam guiding device (16) is inserted into the working gap (20), and wherein the second beam guiding device (16) guides the optical radiation (34) emitted by the radiation source substantially parallel to the working surfaces (16, 18) into the working gap (20) at first, deflects said radiation onto the respective other one of the two working surfaces (16, 18) at a measuring point by means of at least one deflecting surface (30), receives radiation reflected by this working surface (16, 18) and guides said radiation back out of the working gap (20) to an optical detector device, an analysis device being designed to determine the position of this working surface (16, 18) based on a detection result of the detector device, and
the second beam guiding device also comprises a fluid inlet connected to a fluid supply, by means of which at least one second measurement area permeated by the optical radiation (34) after exiting the exit opening (32) of the second beam guiding device (26) in the working gap (20) can be flushed.

9. (canceled)

10. Double-sided machine tool according to claim 1, wherein it is a through-feed machine tool in which the work pieces to be machined are guided into the working gap (20) and out of the same during their machining process.

11. Double-sided machine tool according to claim 1, wherein at least one rotor disc is disposed in the working gap (20), said rotor disc receiving work pieces to be machined in recesses and being adapted to be rotated by means of a roll off device, whereby the at least one rotor disc, and together with it the work pieces received therein, move in the working gap (20) along cycloidal paths.

12. Double-sided machine tool according claim 1, wherein it comprises a control system, which adjusts the position of the working surface (16, 18) and/or the width of the working gap (20) to a constant value, based on the position of the working surface (16, 18) determined by the analysis device.

13. Method for determining the position of a working surface of a working disc of a double-sided machine tool, a double sided grinder in particular, comprising the steps:
providing a double-sided machine tool comprising two working discs (12, 14), which form a working gap (20) for double sided machining of work pieces between working surfaces (16, 18) facing each other, and of which at least one is rotatingly drivable, the tool comprises an optical measurement device (24) having a radiation source, an optical detector device, and an analysis device, designed for being disposed outside of the working gap, wherein the tool comprises a beam guiding device (26), designed for being at least partially inserted in the working gap (20), wherein the beam guiding device (26) has an exit opening (32) for optical radiation (34) generated by the radiation source, said exit opening being situated in the working gap (20) when the beam guiding device (16) is inserted into the working gap (20), and wherein the beam guiding device (16) guides the optical radiation (34) emitted by the radiation source substantially parallel to the working surfaces (16, 18) into the working gap (20), deflects said radiation onto a working surface (16, 18) at a measuring point by means of at least one deflecting surface (30), receives radiation reflected by the working surface (16, 18) and guides said radiation back out of the working gap (20) to the optical detector device, the analysis device being designed to determine the position of the working surface (16, 18) based on a detection result of the detector device, and
the beam guiding device (26) comprises a fluid inlet (38) connected to a fluid supply, by means of which the at least one measurement area permeated by the optical radiation (34) after exiting the exit opening (32) of the beam guiding device (26) in the working gap (26) can be flushed,
a beam guiding device (26) is at least partially inserted into the working gap (20), wherein the beam guiding device (26) has an exit opening (32) for optical radiation (34) generated by the radiation source, said exit opening being situated in the working gap (20) when the beam guiding device (16) is inserted into the working gap (20),
optical radiation generated by an optical radiation source is guided, coming from the radiation source, substantially parallel to the working surfaces (16, 18) into the working gap (20) by the beam guiding device (26) at first, deflected onto a working surface (20) at a measuring point by means of at least one deflecting surface (30),
radiation (34) reflected by the working surface (20) is received by the beam guiding device (26) and guided back out of the working gap (20) to an optical detector device,
the position of the working surface (16, 18) is determined by way of a detection result of the detector device, and
at least during guiding the optical radiation (34) onto the working surface (16, 18) and receiving the radiation (34) reflected by the working surface (16, 18), a measurement area permeated by the optical radiation (34) after exiting the exit opening (32) of the beam guiding device (26) in the working gap (26) is flushed.

14. Method according to claim 13, wherein it is performed during double sided machining of work pieces in the working gap (20).

15. Method according to claim 13, wherein based on the position of the working surface (16, 18) determined by the analysis device, the position of the working surface (16, 18) and/or the thickness of the working gap (20) is adjusted to a constant value.

16. Method according to claim 13, wherein it is performed in a double sided machine tool which is a through-feed tool in which the work pieces to be machined are guided into the working gap (20) and out of the same during their machining process.
